(19) United States
(12) Patent Application Publication
(10) Pub. No.: US 2012/0120991 A1
(43) Pub. Date: May 17, 2012

(54) BASE STATION ANTENNA DEVICE EMBEDDED WITH TRANSMISSION AND RECEIVING MODULE

(75) Inventors: In Jong Seo, Gwangju-shi (KR); In Ho Cho, Gwangju-shi (KR); Jung Kun Oh, Shiheung-shi (KR); Yong Hee Lee, Shiheung-shi (KR); Cheon Hee Lee, Seongnam-shi (KR)

(73) Assignee: ACE TECHNOLOGIES CORP., Incheon-shi (KR)

(21) Appl. No.: 13/383,520

(22) PCT Filed: Jul. 22, 2010
(86) PCT No.: PCT/KR10/04805

§ 371 Date: Jan. 11, 2012

(30) Foreign Application Priority Data
Jul. 27, 2009 (KR) 10-2009-0068192

(51) Int. Cl. H04W 88/12

(52) U.S. Cl. 375/219

(57) ABSTRACT

A base station antenna device containing a transmission and reception module is provided, which includes at least one antenna element configured to transmit and receive RF signals; the transmission and reception module configured to be connected to the antenna element and to form transmission and reception paths for the RF signals; a digital control module configured to digitally control the RF signals transmitted and received by the antenna element by transmitting digital control signals to the transmission and reception module; and a power supply configured to supply operating power to the transmission and reception module and the digital control module.

### TECHNICAL FIELD

The present invention relates, in general, to a base station antenna device containing a transmission and reception module and, more particularly, to a base station antenna device containing a transmission and reception module, in which digital phase regulators and digital attenuators are provided in the transmission and reception module forming transmission and reception paths for RF signals so as to enable electronic beam control, and in which the transmission and reception module is integrated with and contained in an antenna element, thereby reducing power loss, decreasing signal noise, and improving antenna characteristics.

### BACKGROUND ART

FIG. 1 is a schematic diagram showing the configuration of a conventional base station antenna device 10.

As shown in FIG. 1, the conventional base station antenna device 10 includes at least one antenna element 11 for transmitting and receiving RF signals and a power divider 12 for distributing and combining the RF signals.

Here, a cable 2 is connected between the base station antenna device 10 and a base station 1, and therefore the RF signals are input and output to and from the base station 1. A transmission and reception unit 3 for forming a transmission path for RF signals that are transmitted from the base station 1 to the base station antenna device 10 or a reception path for RF signals that are transmitted from the base station antenna device 10 to the base station 1 is formed in the base station 10.

However, when the transmission and reception paths for RF signals are formed in the base station 1, a high power amplifier 4 used to amplify RF signals that form the transmission path and that are transmitted is included in the transmission and reception unit 3 within the base station 1, so that a problem arises in that transmission efficiency is deteriorated by the cable 2 that connects the base station antenna device 10 and the base station 1 to each other. Furthermore, the high power amplifier 4 requiring high power should be employed to increase transmission efficiency, and therefore a cable suitable for high power output by the high power amplifier 4 is employed, so that another problem arises in that the cable deployment cost increases.

Moreover, a low-noise amplification unit 5 used to amplify RF signals that form the reception path and that are received is included in the transmission and reception unit 3 within the base station 1, so that a problem arises in that signal noise is generated in the received RF signals by the cable 2 that connects the base station antenna device 10 and the base station 3 to each other.

As a result, a technology for a practical, useful base station antenna device that is capable of reducing power loss, corresponding cost, and signal noise is highly demanded.

### DISCLOSURE

### Technical Problem

Accordingly, the present invention has been made keeping in mind the above problems occurring in the prior art, and an object of the present invention is to provide a base station antenna device containing a transmission and reception module, which contains the transmission and reception module for forming transmission and reception paths for RF signals, thereby reducing power loss and signal noise.

Another object of the present invention is to provide a base station antenna device containing a transmission and reception module, which includes digital phase regulators and digital attenuators in a transmission unit and a reception unit included in the transmission and reception module and adjusts the phases and magnitude of RF signals, thereby improving antenna characteristics.

A further object of the present invention is to efficiently implement the configuration of control lines connected to a digital control module by including SPC modules in the transmission unit and the reception unit, and to improve the linearity of a high power amplifier by including an AAL module in the transmission unit, thereby enabling the stable, high-quality transmission of signals.

Yet another object of the present invention is to reduce power loss and installation cost by further including mixers for converting an RF signal, that is, a high frequency signal, and an IF signal, that is, an intermediate frequency signal, into each other in the transmission unit and the reception unit included in the transmission and reception module.

### Technical Solution

In order to accomplish the above objects, the present invention provides a base station antenna device containing a transmission and reception module, including at least one antenna element configured to transmit and receive RF signals; the transmission and reception module configured to be connected to the antenna element and to form transmission and reception paths for the RE signals; a digital control module configured to digitally control the RF signals transmitted and received by the antenna element by transmitting digital control signals to the transmission and reception module; and a power supply configured to supply operating power to the transmission and reception module and the digital control module.

### Advantageous Effects

As described above, the present invention has the advantage of providing the base station antenna device containing a transmission and reception module, which contains the transmission and reception module for forming the transmission and reception paths for RF signals, thereby reducing power loss and signal noise.

Furthermore, the present invention has the advantage of providing the base station antenna device to which active phased array technology capable of improving antenna characteristics, such as beam directionality and directional gain in an area requiring an antenna beam pattern, by adjusting the phase and magnitude of an RF signal has been applied because the digital phase regulators and the digital attenuators are included in the transmission unit and the reception unit included in the transmission and reception module so as to enable electronic beam control.

Moreover, the present invention has the advantage of efficiently implementing the configuration of control lines connected to the digital control module because the SPC modules are included in the transmission unit and the reception unit, and the advantage of improving the linearity of the high power amplifier and ultimately enabling the stable, high-quality transmission of signals because the AAL module is included in the transmission unit.

Additionally, the present invention has the advantages of reducing power loss and installation cost because the mixers for converting an RF signal, that is, a high frequency signal, and an IF signal, that is, an intermediate frequency signal, into each other are further included in the transmission unit and the reception unit included in the transmission and reception module.

### DESCRIPTION OF DRAWINGS

FIG. 1 is a schematic diagram showing the configuration of a conventional base station antenna device;

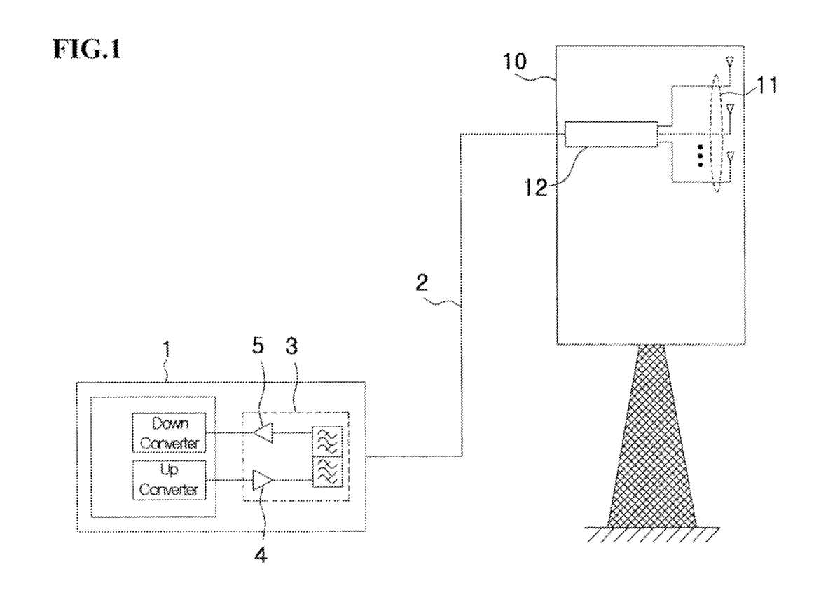

FIG. 2 is a schematic diagram showing the configuration of a base station antenna device that is connected to a base station via an RF cable and contains a transmission and reception module according to an embodiment of the present invention;

FIG. 3 is a detailed diagram showing the configuration of the transmission and reception module integrally contained in the base station antenna device according to the embodiment of the present invention;

FIG. 4 is a diagram showing a configuration in which SPC modules and an adaptive analog linearization module have been added to the transmission and reception module of FIG. 3;

FIG. 5 is a schematic diagram showing the configuration of a base station antenna device that is connected to a base station by an IF cable and contains a transmission and reception module according to another embodiment of the present invention;

FIG. 6 is a detailed diagram showing the configuration of the transmission and reception module integrally contained in the base station antenna device according to another embodiment of the present invention; and

FIG. 7 is a diagram showing a configuration in which SPC modules and an adaptive analog linearization module have been added to the transmission and reception module of FIG. 6.

### MODE FOR INVENTION

Base station antenna devices 100 and 200 containing transmission and reception modules according to the present invention relate to base station antenna devices, each of which receives signals from a base station 101 or 201 and transmits the signals to free space or each of which transmits signals received from free space to the base station 101 or 201.

Preferred embodiments of the present invention will be described in detail below with reference to the accompanying drawings.

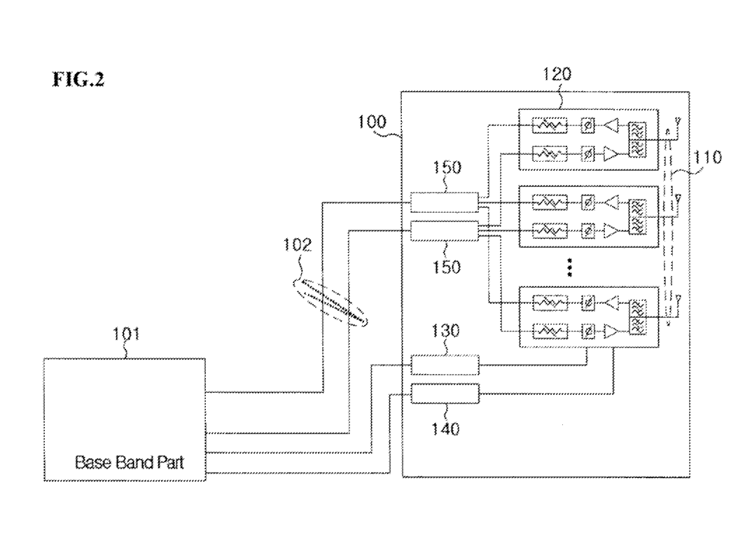

FIG. 2 is a schematic diagram showing the configuration of a base station antenna device that is connected to a base station via an RF cable and contains a transmission and reception module according to an embodiment of the present invention.

As shown in FIG. 2, a base station antenna device 100 containing a transmission and reception module according to the embodiment of the present invention includes at least one antenna element 110 configured to transmit and receive RF signals; a transmission and reception module 120 configured to be connected to the antenna element 110 and to form transmission and reception paths for the RF signals; a digital control module 130 configured to digitally control the RF signals transmitted and received by the antenna element 110 by transmitting digital control signals to the transmission and reception module 120; and a power supply 140 configured to supply operating power to the transmission and reception module 120 and the digital control module 130.

Furthermore, the base station antenna device 100 containing a transmission and reception module according to the embodiment of the present invention further includes a plurality of power dividers 150 that distribute and combine transmission and reception signals, input and output via the transmission and reception paths formed in the transmission and reception module 120, with respect to the same signals.

Here, it is preferred that the power dividers 150 be connected between the transmission and reception module 120 and the base station 101 via RF cables 102.

Meanwhile, in the embodiment of the present invention, it is preferred that the at least one antenna element 110 be a dipole antenna with dual polarization characteristics that is widely used as a base station antenna device to transmit RF signals to free space or to receive RF signals from free space.

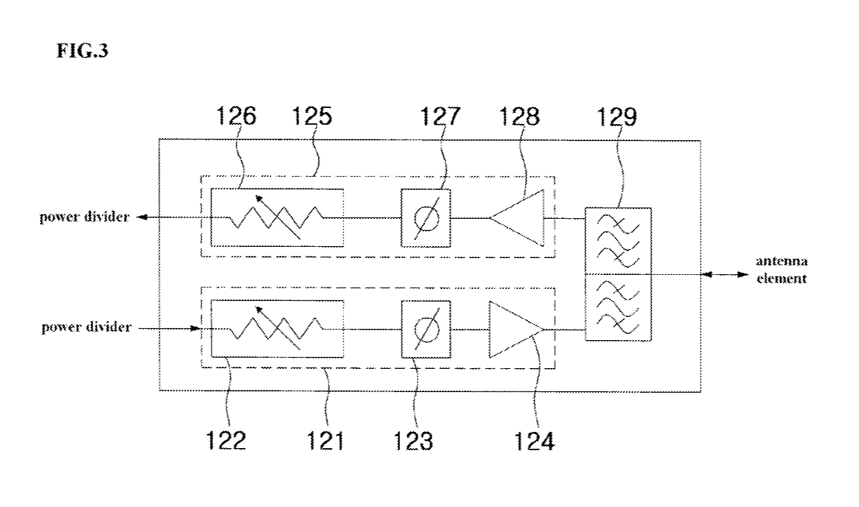

FIG. 3 is a detailed diagram showing the configuration of the transmission and reception module integrally contained in the base station antenna device according to the embodiment of the present invention.

As shown in FIG. 3, the transmission and reception module 120 according to the embodiment of the present invention includes a transmission unit 121 including a digital attenuator 122 for forming a transmission path for an RF signal, receiving a digital control signal from the digital control module 130, and adjusting the magnitude of the RE signal on the transmission path, a first digital phase regulator 123 for receiving a digital control signal from the digital control module 130, and adjusting the phase of the RF signal on the transmission path, and a high power amplifier 124 for amplifying the power of the RF signal on the transmission path; a reception unit 125 including a digital attenuator 126 for forming a reception path for the RF signal, receiving a digital control signal from the digital control module 130, and adjusting the amplitude of the RF signal on the reception path, a second digital phase regulator 127 for receiving a digital control signal from the digital control module 130, and adjusting the phase of the RF signal on the reception path, and a low noise amplifier 128 for preventing noise by amplifying the power of the RF signal on the reception path; and a duplexer 129 for separating the RF signals into a transmission signal for the transmission path for the RF signal formed in the transmission unit 121 and a reception signal for the reception path for the RF signal formed in the reception unit 125.

Here, an operating procedure in which the transmission and reception paths for RF signals are formed by the transmission module 120 including the transmission unit 121, the reception unit 125, and the duplexer 129 will be described in detail below with reference to FIG. 3.

The transmission path for RF signals formed by the transmission unit 121 will be described. When an RF signal transmitted by the base station 101 is input via the power divider 150, the RF signal is supplied to the high power amplifier 124 with the amplitude of the RF signal adjusted by the digital attenuator 122 and with the phase of the RF signal adjusted by the first digital phase regulator 123, the RF signal supplied to the high power amplifier 124 is amplified, and only an RF signal in a desired frequency band is transmitted to the antenna element 110 via the duplexer 129.

As described above, the base station antenna device 100 containing a transmission and reception module according to the embodiment of the present invention can reduce the loss in the power of an RF signal to be transmitted from the base station 101 to the base station antenna device 100 using the transmission and reception module 120 having the transmission unit 121 including the high power amplifier 124, so that the base station 101 can efficiently use power and so that the cost of the installation of transmission cables, suitable for the high power amplifier 124, that connects the base station antenna device 100 and the base station 101 to each other can be reduced.

Furthermore, the reception path for RF signals formed by the reception unit 125 will be described. Only an RF signal in a desired frequency band is extracted from an RF signal, received via the antenna element 110, by the duplexer 129, the extracted RF signal is amplified by the low noise amplifier 128, the phase of the amplified RF signal is changed by the second digital phase regulator 127, and the RF signal is transmitted to the power divider 150 with the magnitude thereof adjusted by the digital attenuator 126.

As described above, the base station antenna device 100 containing a transmission and reception module according to the embodiment of the present invention directly amplifies an RF signal, received by the antenna element 110, within the base station antenna device 100 using the transmission and reception module 120 having the reception unit 125 including the low noise amplifier 128, so that the signal noise of an RF signal that is transmitted from the base station antenna device 100 to the base station 101 can be reduced.

Meanwhile, the base station antenna device 100 containing a transmission and reception module according to the embodiment of the present invention includes the digital phase regulators 123 and 127 and the digital attenuators 122 and 126 in the transmission unit 121 and the reception unit 125 included in the transmission and reception module 120 so as to enable electronic beam control, thereby achieving the advantage of providing a base station antenna device to which active phased array technology capable of improving antenna characteristics, such as beam directionality and directional gain in an area requiring an antenna beam pattern, by adjusting the phase and magnitude of an RF signal has been applied.

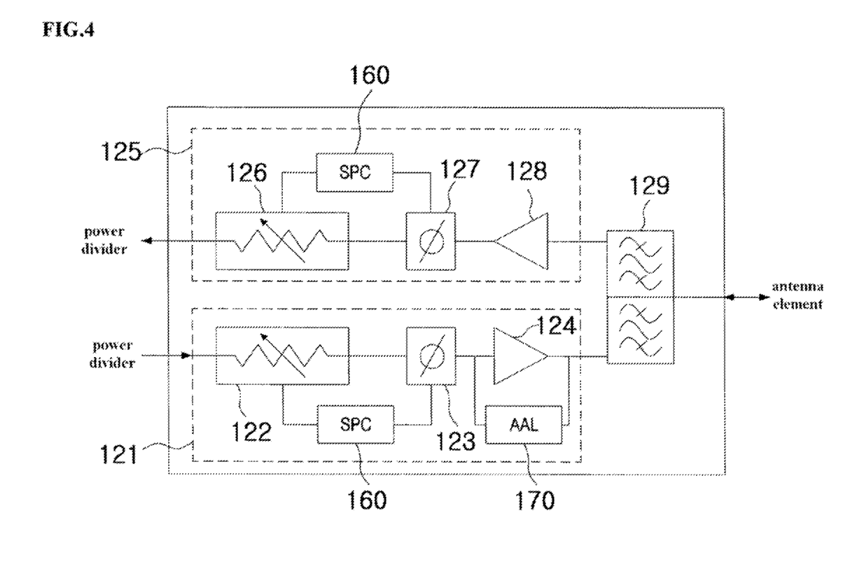

FIG. 4 is a diagram showing a configuration in which SPC modules and an adaptive analog linearization module have been added to the transmission and reception module of FIG. 3.

As shown in FIG. 4, the base station antenna device 100 containing a transmission and reception module according to an embodiment of the present invention includes Serial-to-Parallel Converter (SPC) modules 160 in the transmission unit 121 and the reception unit 125 in order to efficiently implement control lines connected to the digital control module 130, and further includes an Adaptive Analog Linearization (AAL) module 170, suitable for small power, in the transmission unit 121 and allows it to be installed in the high power amplifier, thereby improving the linearity of the high power amplifier and ultimately enabling the stable, high-quality transmission of signals.

In greater detail, the SPC modules 160 function to allow a plurality of parallel control signals to be simultaneously output when serial control signals are input at regular intervals, which reduces a number of control lines that are required to interconnect the digital control module 130, the digital attenuators 122 and 126 and the digital phase regulators 123 and 127.

Furthermore, the adaptive analog linearization module 170 can solve the problem of being unable to include the transmission and reception module 120 in the antenna device because the size thereof is increased when Digital Pre-Distortion (DPD), which is an linearization improvement scheme used in a conventional mobile communication base station, is employed, and therefore the adaptive analog linearization module 170 can be designed for small power so that it can be installed in the high power amplifier 124 included in the transmission unit 121, thereby enabling System On Chip (SOC) implementation.

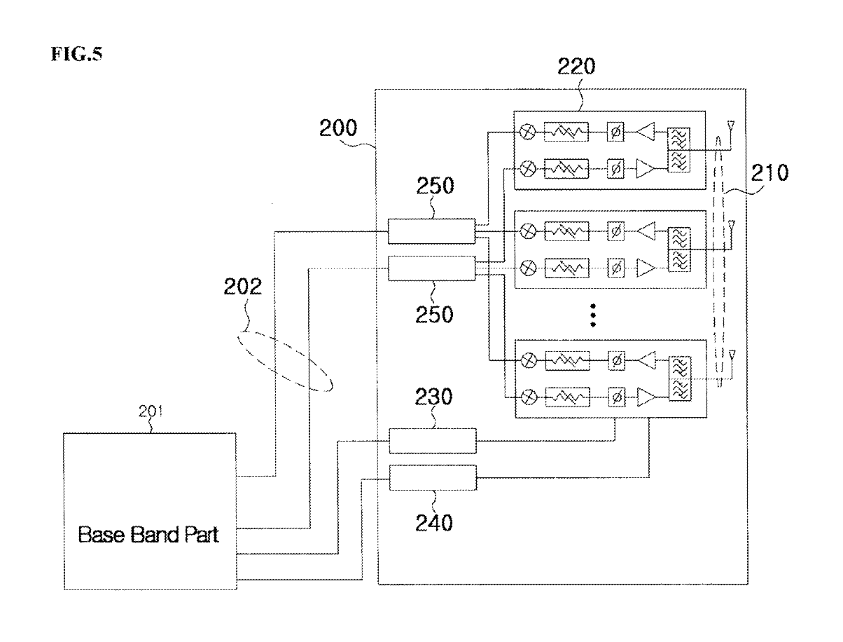

FIG. 5 is a schematic diagram showing the configuration of a base station antenna device that is connected to a base station by IF cables and contains a transmission and reception module according to another embodiment of the present invention.

As shown in FIG. 5, a base station antenna device 200 containing a transmission and reception module according to another embodiment of the present invention includes at least one antenna element 210 configured to transmit and receive RF signals; a transmission and reception module 220 configured to be connected to the antenna element 210 and to form transmission and reception paths for the RF signals; a digital control module 230 configured to digitally control the RF signals transmitted and received by the antenna element 210 by transmitting digital control signals to the transmission and reception module 220; and a power supply 240 configured to supply power to the transmission and reception module 220 and the digital control module 230.

Furthermore, the base station antenna device 200 containing a transmission and reception module according to another embodiment of the present invention further includes a plurality of power dividers 250 that distribute and combine transmission and reception signals, input and output via the transmission and reception paths formed in the transmission and reception module 220, with respect to the same signals.

Here, it is preferred that the power dividers 250 be connected between the transmission and reception module 220 and the base station 201 by IF cables 202.

Meanwhile, in another embodiment of the present invention, it is preferred that the at least one antenna element 210 be a dipole antenna with dual polarization characteristics that is widely used as a base station antenna device to transmit RF signals to free space or to receive RF signals from free space.

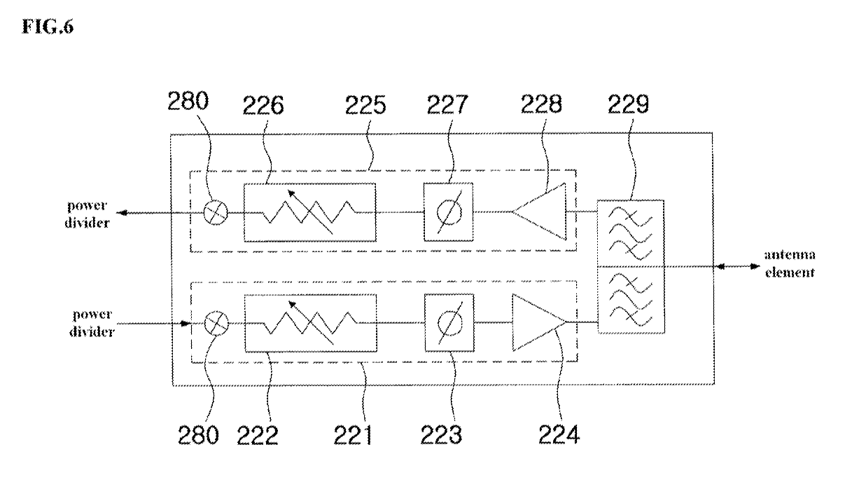

FIG. 6 is a detailed diagram showing the configuration of the transmission and reception module integrally contained in the base station antenna device according to another embodiment of the present invention. Since components that are the same as those of FIG. 3 have the same characteristics, detailed descriptions thereof will be omitted here.

As shown in FIG. 6, the transmission and reception module 220 according to another embodiment of the present invention includes a transmission unit 221 including a digital attenuator 222, a first digital phase regulator 223 and a high power amplifier 224; a reception unit 225 including a digital attenuator 226, a second digital phase regulator 227 and a low noise amplifier 228; and a duplexer 229 for separating transmission and reception signals.

In this case, in accordance with another embodiment of the present invention, each of the transmission unit 221 and the reception unit 225 further includes a mixer 280 that converts an RF signal, that is, a high frequency signal, into an IF signal, that is, an intermediate frequency signal, or an IF signal, that is, an intermediate frequency signal, into an RF signal, that is, a high frequency signal.

Here, the mixer 280 functions to convert the frequency. That is, the mixer 280 up-converts an RF signal in a high frequency band (1˜2 GHz), input to the transmission and reception module 220 by the antenna element 210, into an IF signal in a low frequency band (hundreds of MHz) and transmits the resulting signal to the base station 201 via the power dividers 250, or up-converts an IF frequency signal in a low frequency band, input from the base station 201 via the power dividers 250, into an RE frequency signal in a high frequency band to transmit the resulting signal to the antenna element 210.

As described above, the base station antenna device according to another embodiment of the present invention further includes the mixers 280 for converting the frequency in the transmission unit 221 and reception unit 225 of the integrally contained transmission and reception module 220 and therefore allows IF cables, instead of expensive RF cables having high power loss, to be installed and used between the base station 201 and the transmission and reception module 220, thereby providing the advantage of reducing power loss and installation cost.

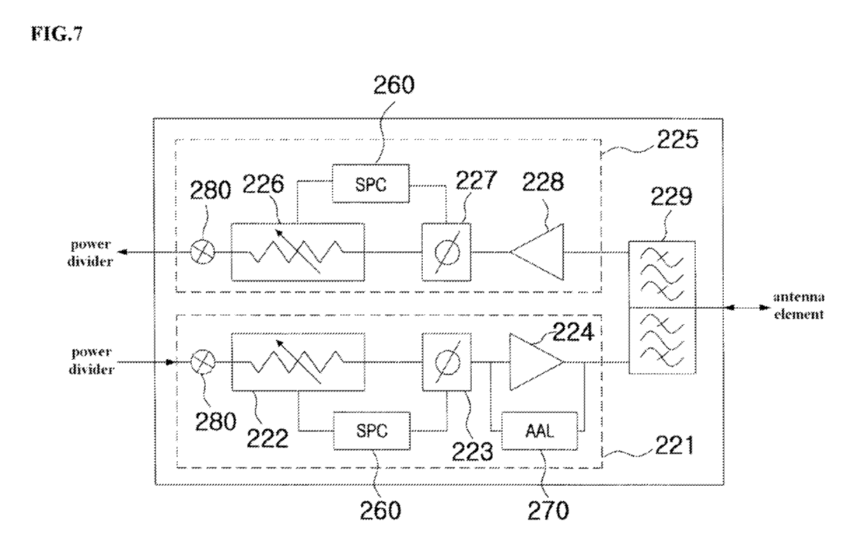

FIG. 7 is a diagram showing a configuration in which SPC modules and an adaptive analog linearization module have been added to the transmission and reception module of FIG. 6.

As shown in FIG. 7, the base station antenna device 200 containing a transmission and reception module according to another embodiment of the present invention includes Serial-to-Parallel Converter (SPC) modules 260 in the transmission unit 221 and the reception unit 225 in order to efficiently implement control lines connected to the digital control module 230, and further includes an Adaptive Analog Linearization (AAL) module 270, suitable for small power, in the transmission unit 221 and allows it to be installed in the high power amplifier, thereby improving the linearity of the high power amplifier and ultimately enabling the stable, high-quality transmission of signals.

In greater detail, the SPC modules 260 function to allow a plurality of parallel control signals to be simultaneously output when serial control signals are input at regular intervals, which reduces a number of control lines that are required to interconnect the digital control module 230, the digital attenuators 222 and 226 and the digital phase regulators 223 and 227.

Furthermore, the adaptive analog linearization module 270 can solve the problem of being unable to include the transmission and reception module 220 in the antenna device because the size thereof is increased when Digital Pre-Distortion (DPD), which is an linearization improvement scheme used in a conventional mobile communication base station, is employed, and therefore the adaptive analog linearization module 270 can be designed for small power so that it can be installed in the high power amplifier 224 included in the transmission unit 221, thereby enabling System On Chip (SOC) implementation.

As described above, the present invention has the advantage of providing the base station antenna device containing a transmission and reception module, which contains the transmission and reception module for forming the transmission and reception paths for RF signals, thereby reducing power loss and signal noise.

Furthermore, the present invention has the advantage of providing the base station antenna device to which active phased array technology capable of improving antenna characteristics, such as beam directionality and directional gain in an area requiring an antenna beam pattern, by adjusting the phase and magnitude of an RF signal has been applied because the digital phase regulators and the digital attenuators are included in the transmission unit and the reception unit included in the transmission and reception module so as to enable electronic beam control.

Moreover, the present invention has the advantage of efficiently implementing the configuration of control lines connected to the digital control module because the SPC modules are included in the transmission unit and the reception unit, and the advantage of improving the linearity of the high power amplifier and ultimately enabling the stable, high-quality transmission of signals because the AAL module is included in the transmission unit.

Additionally, the present invention has the advantages of reducing power loss and installation cost because the mixers for converting an RF signal, that is, a high frequency signal, and an IF signal, that is, an intermediate frequency signal, into each other are further included in the transmission unit and the reception unit included in the transmission and reception module.

Although the present invention has been described in detail so far, it will be apparent that the embodiments mentioned in the description are merely illustrative but not limitative. Equivalent changes of components made without departing from the technical spirit and scope of the present invention defined by the following claims pertain to the scope of the present invention.

1. A base station antenna device containing a transmission and reception module, comprising:
at least one antenna element configured to transmit and receive RF signals;
the transmission and reception module configured to be connected to the antenna element and to form transmission and reception paths for the RF signals;
a digital control module configured to digitally control the RF signals transmitted and received by the antenna element by transmitting digital control signals to the transmission and reception module; and
a power supply configured to supply operating power to the transmission and reception module and the digital control module.

2. The base station antenna device according to claim 1, further comprising a plurality of power dividers for distributing and combining transmission and reception signals, input and output via the transmission and reception paths formed in the transmission and reception module, with respect to identical signals.

3. The base station antenna device according to claim 1, wherein the transmission and reception module comprises:
a transmission unit comprising a digital attenuator for forming the transmission path for the RF signal, receiving the digital control signal from the digital control module, and adjusting magnitude of the RF signal on the transmission path, a first digital phase regulator for receiving the digital control signal from the digital control module, and adjusting a phase of the RF signal on the transmission path, and a high power amplifier for amplifying power of the RF signal on the transmission path;
a reception unit comprising a digital attenuator for forming the reception path for the RF signal, receiving the digital control signal from the digital control module, and adjusting amplitude of the RF signal on the reception path, a second digital phase regulator for receiving the digital control signal from the digital control module, and adjusting a phase of the RF signal on the reception path, and a low noise amplifier for preventing noise by amplifying power of the RF signal on the reception path; and
a duplexer for separating t he RF signals into a transmission signal for the transmission path for the RF signal formed in the transmission unit and a reception signal for the reception path for the RF signal formed in the reception unit.

4. The base station antenna device according to claim 3, wherein each of the transmission unit and the reception unit further comprises a mixer for converting an RF signal, that is, a high frequency signal, into an IF signal, that is, an intermediate frequency signal, or an IF signal, that is, an intermediate frequency signal, into an RF signal, that is, a high frequency signal.

5. The base station antenna device according to claim 3, wherein the transmission unit further comprises an Adaptive Analog Linearization (AAL) module installed in the high power amplifier so as to improve linearity of the high power amplifier.

6. The base station antenna device according to claim 5, wherein each of the transmission unit and the reception unit further comprises a Serial-to-Parallel Converter (SPC) module for simultaneously outputting a plurality of control signals when a single serial control signal is input so as to reduce control lines connected to the digital control module.

7. The base station antenna device according to claim 4, wherein the transmission unit further comprises an Adaptive Analog Linearization (AAL) module installed in the high power amplifier so as to improve linearity of the high power amplifier.

8. The base station antenna device according to claim 7, wherein each of the transmission unit and the reception unit further comprises a Serial-to-Parallel Converter (SPC) module for simultaneously outputting a plurality of control signals when a single serial control signal is input so as to reduce control lines connected to the digital control module.
